(19) United States
(12) Patent Application Publication
(10) Pub. No.: US 2008/0223397 A1
(43) Pub. Date: Sep. 18, 2008

(54) Dental floss and tape dispenser

(76) Inventor: Russell R. Yates, Englewood, NJ (US)

Correspondence Address: Charles E. Temko, 22 Marion Road, Westport, CT, 06880-2922, US

(21) Appl. No.: 11/901,353

(22) Filed: Sep. 18, 2007

Related U.S. Application Data
(60) Provisional application No. 60/895,451, filed on Mar. 17, 2007.

(51) Int. Cl. A61C 15/04; A61C 15/00

(52) U.S. Cl. 132/324; 132/323

(57) ABSTRACT

A dental floss dispenser suited for mounting upon a planar surface surrounding a bathroom sink or wall for instant availability. It includes a reloadable housing having an exit opening, and may be used for dental tape or plural spools of dental floss material. The housing supports a laterally extending cutting blade member having a recess accommodating the thumb and fingers holding a segment of material to be severed. The device may be used for selective dispensing of both dental tape and dental floss,

### RELATED APPLICATION

Reference is made to my co-pending provisional application Ser. No. 60-895,451 filed Sep. 18, 2006, to which a claim of priority is made.

### BACKGROUND OF THE INVENTION

This invention relates generally to the field of dispensers for dental floss and dental tape, and more particularly to an improved dispenser suitable for mounting at a relatively fixed location in a bathroom, typically upon a sink or cabinet.

The prior art in this field has largely consisted of disposable pocket-sized devices for dispensing floss from a spool disposed within an elongated container having cutting means incorporated into a cap at one end thereof. Such devices are not without utility, but are not usually available at a time when they are most often used i.e. at the time of brushing the teeth of the user as a part of other toilet procedures. Fixed devices are not unknown in the art, but have not received significant acceptance by the public because of various shortcomings, such as size, difficulty in use, high cost of manufacture and the like. There thus arises a need for an improved device of this type which addresses the above mentioned shortcomings.

### SUMMARY OF THE INVENTION

Briefly stated, the invention contemplates the provision of an improved device of the class described which, in addition to resolving the above mentioned problems, includes provision for reloading of the contents when exhausted, is capable of selective dispensing both dental floss and dental tape, is easy to use, and which may be conveniently manufactured at reasonable cost employing a minimum number of component parts.

### BRIEF DESCRIPTION OF THE DRAWINGS

In the drawings, to which reference will be made in the specification, similar reference characters have been employed to designate corresponding parts throughout the several views.

FIG. 1 is an exploded view in perspective of an embodiment of the invention.

FIG. 2 is a front elevational view of a housing element forming part of the disclosed embodiment.

FIG. 3 is a schematic sectional view thereof

### DETAILED DESCRIPTION OF THE DECLOSED EMBODIMENT

In accordance with the invention, the device, generally indicated by reference character 10 comprises broadly: a housing element 11, a floss and tape retaining element 12, and a base element 13.

The housing element 11 is a generally rectangular configuration, and is most conveniently of injection molded construction. It includes and outer wall 20, and upper wall 21, a lower wall 22, first and second side walls 23 and 24, respectively, and a laterally extending cutting member 25. The outer wall 20 is bounded by an inner surface 29 and an outer surface 30 (FIG. 3), the inner surface having vertically extending reinforcing members 31 and 32. The side walls 23-24 include vertically elongated slotted openings 34 for the dispensing of floss (not shown). The housing element also includes laterally extending engagement members 35. The laterally extending cutting member 25 includes a finger and thumb recess 37 and a recess 38 for a cutting tool 39 engaged therein.

The retaining element 12 is also preferably of moulded construction, and includes an outer wall 41, a horizontal wall 42 as well as a vertical wall 43. The wall 41 includes laterally position extensions 46 and 47, as well as a rectangular slot 48 overlying a recess 49 for holding a planar tape or dental floss container (not shown). The horizontal wall 42 includes upper and lower surfaces 50 and 51 which may be slightly tapered in configuration to facilitate extraction from a mould. The vertical wall 43 includes a lower end 54 and an upper end 55. When the element 12 is positioned within the housing element 11, there is formed a vertically oriented space for conducting a continuous segment of dental tape, or dental floss container. A coil spring 56 resiliently urges the element 12 upwardly to position the container.

The base element 13 is also of molded construction, and includes an outer surface 60 having a pair of adhesive strips 61 and 62 for attachment of the device to a fixed surface (not shown). An inner surface 63 includes four corners 64, 65, 66, and 67 having engaging flanges 68 which slideably engage the extensions 35 on the housing element, A positioning flange 69 contacts the upper wall 21 to fix the relative position between the housing element and base element.

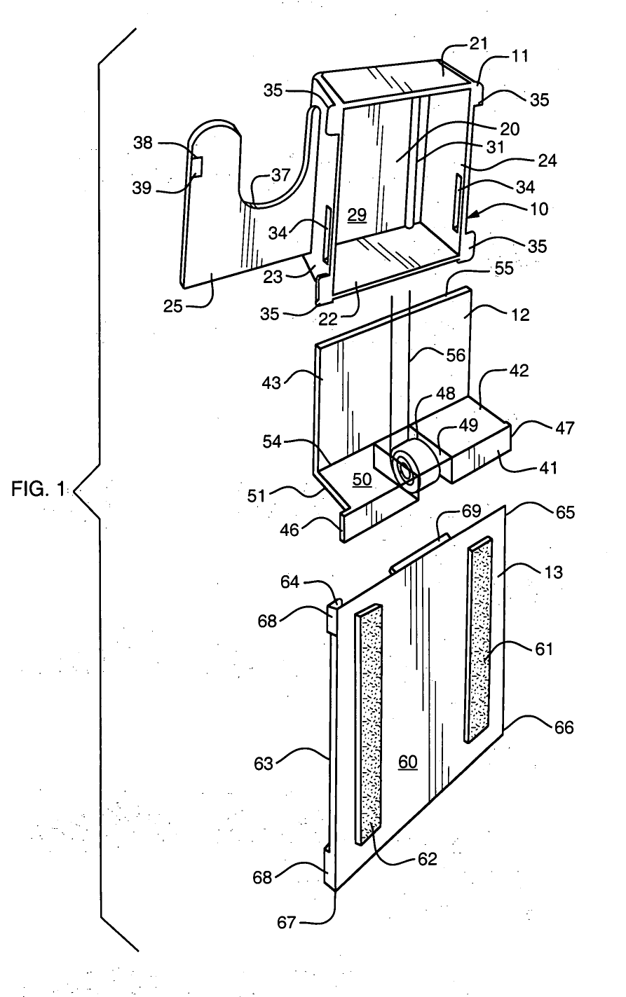

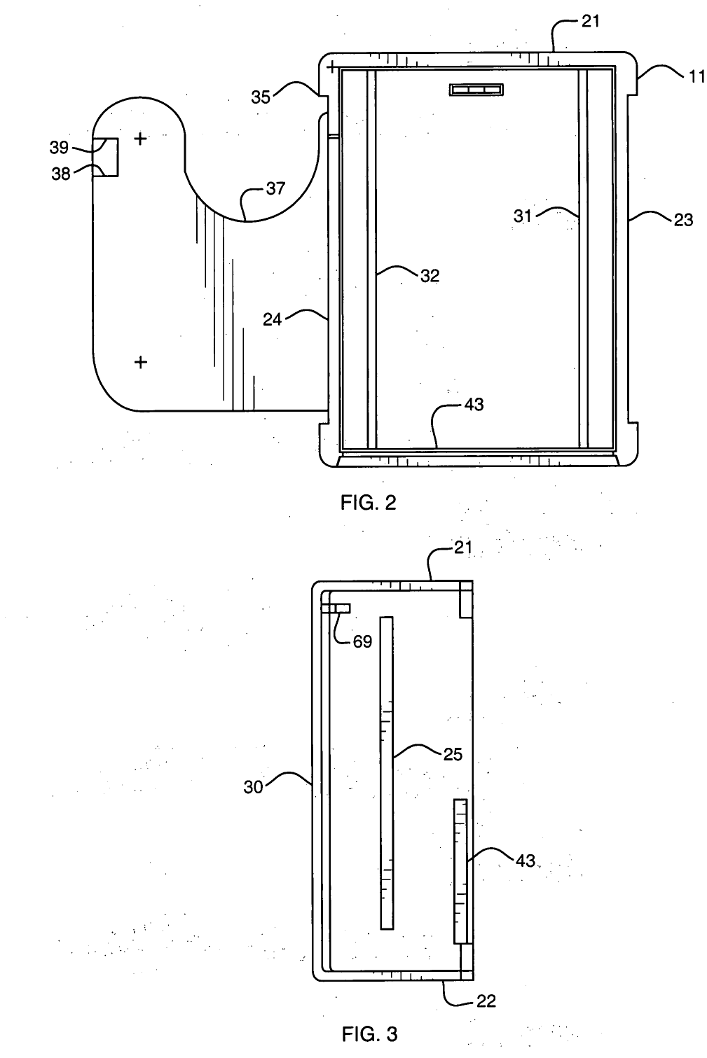

Operation of the device will be apparent for making consideration of FIG. 1. A continuous segment of dental tape or dental floss extends through a selected opening 34 in the housing element so that it may be conveniently grasped and moved to the cutting edge 39 to be severed for use. Since the device may contain several spools of material, it may be used continuously until all of the spools are exhausted, at which time the device can be disassembled for replenishment. As mentioned, the device is conveniently mounted upon a planar surface such as the upper surface of a shelf surrounding a sink, or a similar location.

It may thus be seen that I have invented novel and highly useful improvements in a combination dental floss and dental tape dispenser that enables installation upon a fixed surface for ready availability. The device accommodates a plurality of dental tapes and flosses without adjustment, and may be fabricated substantially by using injection moulding techniques. Component parts may be individually replaced, if necessary.

I wish it to be understood that I do not consider the invention to be limited to the precise details of construction illustrated and described in these specification, for obvious modifications will occur to those skilled in the art to which the invention pertains.

I claim:

1. An improved dental tape and floss dispenser comprising: a housing element, a floss and tape retaining element, and a base element; said housing element forming a hollow enclosure and having a plurality of base element engaging members, and at least one opening for dispensing dental material; said floss and tape retaining element being positioned within said hollow enclosure and forming a recess for holding dental material for dispensing; said base element being a generally planar configuration, and having means for selectively engaging said plurality of base element engaging members wherein said floss and tape element is retained within said housing element.

2. A dispenser in accordance with claim 1 further comprising a laterally extending member carried by said housing element having dental material cutting means thereon.

3. A dispenser in accordance with claim 1, said base element having an outer surface having adhesive surface engaging means for positioning said dispenser in fixed location.

4. A dispenser in accordance with claim 1, said housing element having plural dispensing openings therein for feeding material from plural sources within said housing element.

5. A device in accordance with claim 1, said floss and tape retaining element having resilient means for locating the position thereof relative to said hollow enclosure.
